(19) United States
(12) Patent Application Publication
(10) Pub. No.: US 2007/0231743 A1
(43) Pub. Date: Oct. 4, 2007

(54) Optical media device with minipulatable read capability

(76) Inventors: Richard Selinfreund, Terre Haute, IN (US); Peter Michael Rentzepis, Irvine, CA (US); Craig S. Etchegoyen, Newport Beach, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/394,863

(22) Filed: Mar. 31, 2006

(51) Int. Cl. G11B 7/24

(52) U.S. Cl. 430/270.15; 430/945; 428/64.8; 369/284

(57) ABSTRACT

An optical media device comprises a mask layer placed over a data layer, and that includes chemical ingredients designed to render the data layer unreadable by an optical reader in a first initial state, and allow the data layer to be read when converted to a second state. The mask layer is optically opaque in the first state, and is optically transparent in the second state. The chemical ingredients include a dye that absorbs light in the visible light and/or optical reader spectrum, and a further chemical that is activatable to shift the dye's absorption wavelength so the data layer can be read by the optical reader. The activation source is radiative emission having a wavelength different from that of visible light and/or the optical reader. The activation source can be used at the point of sale of the device to render the device readable upon purchase.

### FIELD OF THE INVENTION

This invention relates to devices that are capable of providing audio, video, or other forms of information that is readable by optical means and, more particularly, to an optical media device that is specially engineered having an anti-theft feature that can transform the device from an unreadable state to a readable state upon the occurrence of an event.

### BACKGROUND OF THE INVENTION

The use of media devices that are configured to accommodate different types of data information that is read by optical means is well known, such as compact disks (CD) for audio data or music, digital video disks (DVDs) for video and/or audio information, and the like. Such optical media devices typically include the information that is contained therein in data layer that is protected by a layer of optically transmissive or transparent material, and the information is read from the data layer of the device by an appropriate optical that is configured to transmit a beam of light through the transmissive material and to the data layer. Accordingly, the use of such optical media devices is popular for the distribution of digital movies and music as well as other types of digital products including software. These products are frequently sold through retail outlets.

Due to the relative small size of optical media based packaged goods and their relatively high commercial value, such optical media devices have become popular targets for theft from supply chain retail establishments. Many attempts have been made to deter such unwanted theft of these products. Often attempt has been to focus on the packaging for such optical media in the form of adding identifiers to each package that are configured to trigger an alarm, placed at or near a door of a retail establishment, if the device is taken out of the store without first being removed or deactivated by a sales person upon payment by the customer.

More recent attempts include recent plans to add a radio frequency identification device (RFID) to the product packaging. RFIDs function in a similar fashion to assist a retailer in knowing when someone is attempting to leave the premises without paying for the optical media device.

A disadvantage of the above noted-attempts of controlling the theft of optical media devices is that data contained in the optical media device is provided within the product packaging in a readable form, so that if the items is stolen, e.g., by a person removing optical media device from the packing or disabling the anti-theft device on the packaging, the stolen optical media device can still be read.

A further disadvantage of the above-noted attempts of controlling the theft of optical media devices relates to the amount of time, expense and effort that is involved in first applying the anti-theft device to the packaging, and removing the anti-theft device from the packaging at the point of sale. Since many of these types of anti-theft devices are used over or recycled, the use of such devices creates a cycle of application, removal and reapplication that is time consuming and labor intensive, therefore costly for the retailer.

A still further disadvantage of the above-noted attempts of controlling the theft of optical media devices is that they typically require a large capital cost relating either to the devices themselves that are placed on the packaging, the devices that are used at the point of sale to remove or neutralize the anti-theft device, and/or the devices that are placed within the retail establishment usually near the doors to detect and signal an alarm when within the presence of the anti-theft device.

It is, therefore, desirable that an optical media device be constructed in a manner that provides anti-theft capabilities without many or all of the above-noted disadvantages, and without the reliance of product packaging as a method of providing such anti-theft characteristics. It is further desired that such an optical media device be constructed in such a manner that facilitates ease of use for a retailer.

### SUMMARY OF THE INVENTION

Optical media devices, constructed in accordance with this invention, comprise a data layer, and a protective layer disposed over the data layer. While the presence of a protective layer is disclosed, it is understood that the optical media device of this invention can be constructed without such a protective layer for certain end use applications not requiring a protective layer.

A mask layer is disposed over at least a portion of the data layer. The mask layer comprises one or more chemical ingredients disposed therein. The mask layer exists in two different states. When in an initial or first state, the mask layer is such that it prevents the data layer from being read by an optical reader. When in a second state, the mask layer is such that it permits the data layer to be read by the optical reader. In an example embodiment, when in its first state the mask layer is optically opaque, and when in its second state the mask layer is optically transparent.

The mask layer is generally positioned on the device between the data layer and the optical reader that is used to read the data. The mask layer can exist as its own layer that is positioned over the data layer, or can exist as part of another layer, e.g., a protective layer, that is positioned over the data layer.

The chemical ingredients in the mask layer can be selected from chemical ingredients and chemical compounds that change from the first to the second state upon exposure to an activation source that can be a radiative source, and oxidizing source, and the like. In an example embodiment, the mask layer comprises chemical ingredients that specially selected to change state upon exposure to a radiative actuation source. In such example embodiment, the radiative actuation source emits a wavelength or radiative emission that is different from that used by the optical reader used to access the data layer and/or that outside of the wavelength of the visible light spectrum.

In an example embodiment, the mask layer includes a chemical ingredient in the form of a dye that is specially formulated to absorb visible or the optical reader wavelength radiation. The mask layer also includes a further chemical ingredient that causes the dye to shift its absorption outside of the visible wavelength or the optical reader wavelength spectrum when such further chemical ingredient is exposed to an activating wavelength radiation. In such example embodiment, the activating wavelength radiation is within the nonvisible spectrum that can include within the range of from about 250 nm to 320 nm, and/or that can include radiation having a wavelength within the of ultraviolet, infrared, and/or microwave spectrums.

Optical media devices of this invention are initially manufactured, distributed and displayed in an initially protected or unreadable condition. Once the device has been paid for, e.g., at the point of sale, it can be converted in the manner described above to a subsequent readable condition for the purchaser's use and enjoyment. The device is constructed so that once it has been converted from an initial unreadable state to a subsequent readable state, it can be reliably read for the normal commercial life of the media.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1 is a perspective exploded view of an optical media device construction in accordance with the principles of this invention;

FIG. 2 is a schematic side view of a section of the optical media device of FIG. 1 as used with a selected light emitting and reading device when the optical media device is in a first unreadable state;

FIG. 3 is a schematic side view of a section of the optical media device of FIG. 1 as used with a radiation source for rendering the optical media device readable and placing in a second readable state; and

FIG. 4 is a schematic side view of a section of the optical media device of FIG. 1 as used with a selected light emitting and reading device when the optical media device is in the second readable state.

### DETAILED DESCRIPTION OF THE INVENTION

Optical media devices of this invention comprise a layer of material that is specially formulated to render the data layer within the device unreadable when in an initial first initial state, and render the data layer readable in a second state when activated, e.g., when exposed to a preselected wavelength of radiation.

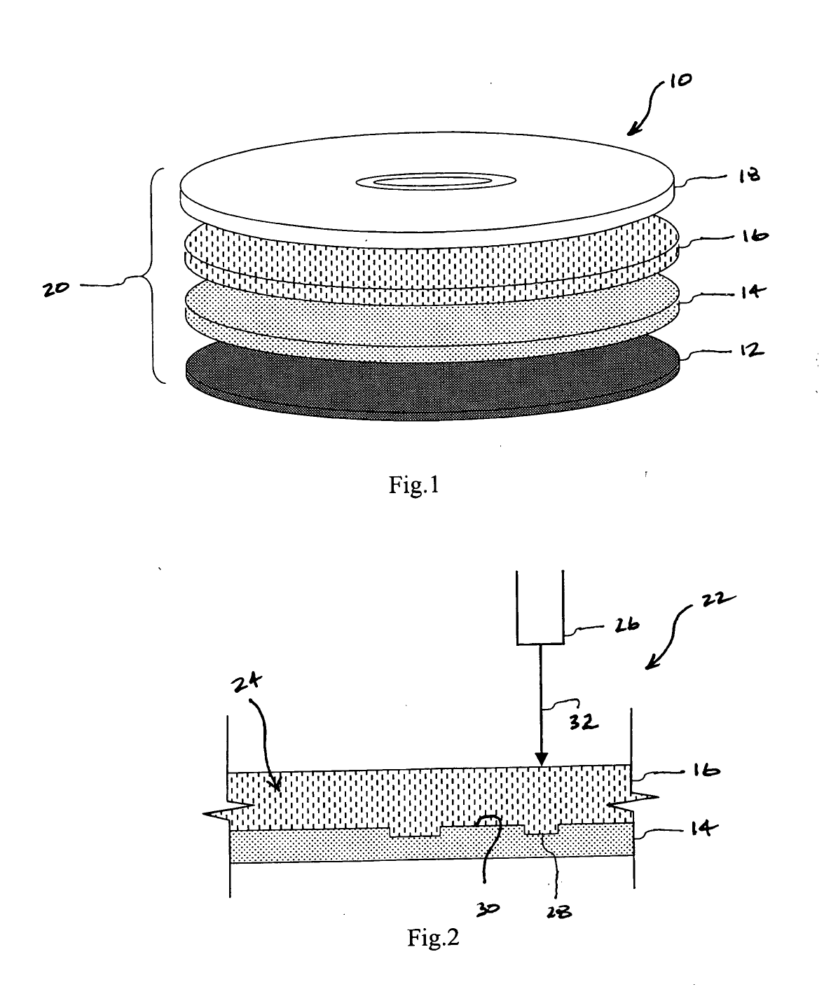

FIG. 1 illustrates an example embodiment optical media device 10, constructed in accordance with the principles of this invention, in an unassembled condition to clearly show the different layers of material making up the same. The device 10 generally comprises a label 12 that is optional and that typically includes a printed indicia and/or is colored to suit the needs or desire of the device manufacturer. The label 12 is placed over what can be referred to as the data layer 14.

The data layer can be formed from a plastic material, such as an acrylic material and comprises a thin-reflective metallic layer of material that is disposed over its surface that is positioned opposite the label. As best shown in FIG. 2, the thin-reflective metallic layer is disposed over a plurality of pits and lands that represent the data stored on the device. In an example embodiment, the thin-reflective metallic layer can be formed from any type of metallic material, and in a preferred embodiment is formed from aluminum.

A mask layer 16 is disposed over the data layer 14 and is made from a specially formulated material that is designed to render the data layer unreadable to an optical reading device when the mask layer is in an initial first state, but that can be activated or converted to render the data later readable when in a second state by exposure to a suitable activating source or device. In an example embodiment, the mask layer 16 is formulated from a material that is capable of being converted from an initially optically opaque or nontransparent state to a transparent state by exposure to an activating event or device. It is desired that the composition used to formulate the masking layer be one that does not otherwise interfere with or impair the structure or operability of the optical media device.

In an example embodiment, the mask layer 16 is disposed onto the data layer 14 of the optical media device 10. However, it is to be understood that the mask layer 16 can be disposed at any position within the optical media device 10 that would be between the data layer 14 and a data reading device, e.g., a laser emitter and reader, used to access the data. Accordingly, the exact placement and/or thickness of the mask layer can and will vary on such factors as the placement location of the mask layer within the optical media device, and the type of material that is used to form the mask layer.

In the example embodiment illustrated in FIG. 1, the mask layer 16 is provided in the form of its own discrete layer interposed between the data layer 14 and a protective outer layer 18. In such example embodiment, the optical media device protective outer layer 18 is formed from a plastic, polymer material such as polycarbonate plastic as used to form conventional CDs, DVDs or the like, and are provided to protect the optical media device from being damaged during shipping and handling. Accordingly, if desired, instead of being provided in the form of its own discrete layer, the mask layer can be provided as part of the protective outer layer 18, in which case such protective layer 18 would disposed directly over the data layer 14. The combination of these layers 20 make up the optical media device.

Materials useful for forming the mask layer 16 include those organic or inorganic chemicals and/or chemical compounds that are capable of being suspended, dissolved, dispersed or contained in a fixed phase of surrounding material or polymer matrix, such as a thermosetting material like plastic, and that can change from an opaque or nontransparent state to a transparent state upon exposure to a predetermined activating source or event. Suitable chemical or chemical compounds include inorganic and organic dyes that are capable, based on concentration and/or density, of preventing the data within the data layer from being read by a light emitting and reading device when in a first state, i.e., a state where the mask layer is opaque or nontransparent.

The dye used to form the mask layer may, by its own chemical nature, be capable of being rendered transparent by virtue of an activating source or event, such as by exposure to an oxidizing and/or radiating condition and/or chemical reaction. Additionally or alternatively, the dye may be rendered transparent by the presence of a further chemical ingredient or compound present in the mask layer that itself is activated by exposure to an activation source and the reaction of such further activated chemical ingredient or compound with the dye. Accordingly, the mask layer can be provided in the form of a single chemical ingredient or compound, or in the form of a system of two or more chemical ingredients or chemical compounds that are specially engineered to provide the second state by reaction between the two or more chemical ingredients or chemical compounds.

In an example embodiment, the mask layer is provided in the form of a chemical system comprising an organic dye that is opaque or nontransparent within the visible wavelength band of the reading device, and a chemical ingredient that is an acid generator when exposed to a predetermined activation wavelength and/or a predetermined wavelength having a specific activation intensity. In an example embodiment, the mask layer comprises a chemical system that us unreadable when exposed to visible wavelength light, and that becomes readable when exposed to an activation wavelength of light that is nonvisible.

In such system, the optical media device is unreadable when exposed to visible wavelength light, and only becomes readable when it is initially exposed to the activating radiation wavelength, which causes the further chemical ingredient to generate acid and cause the dye to shift its light absorption from the visible to the nonvisible wavelength, thereby rendering the optical media transparent and device readable. Configured in this manner, this system prevents the mask layer from converting from a first unreadable state to a second readable state by exposure to light sources and intensities that occur during the normal distribution and display of optical media, e.g., in retail outlets.

In a preferred embodiment, it is desired that the chemical ingredients and/or chemical compounds used to form the masking layer be ones that are capable of promoting the conversion of the optical media device from an initial unreadable first state to a readable second state within a relatively short period of time, e.g., within seconds as better described below.

In such example embodiment, the dye ingredient is a bleachable organic dye such as Sudan blue, and the other chemical ingredient (the acid generator) is triarylsulfonium hexafluorophosphate. Other organic dyes useful in formulating the mask layer of this invention include and are not limited to: indigos; triarylmethane dyes; spiropyrans; and 4,4′-, 7,7′-tetra-substituted-, 1,1′-, and 3,3′-tetraethylbenzimidazolotriazatrimethine cyanines. Suitable indigos include N,N′-dimethyl indigo, N,N′-dimethyl-5,5′,7,7′-tetrabromoindigo, and N,N′-ethylindigo(s). Suitable spiropyrans include spiropyran-modified cyclodextrin, and phenyl substituted spiropyran(s). Suitable triarylmethane dyes include those trimethylmethane(s) having the formulas; R═N(CH₃)₂, R═H, R═N(C₂H₅)₂.

The commercial names of suitable dyes useful with this invention include synthetic indigo, malachite green oxalate salt, brilliant green, crystal violet, ethyl violet, napthol blue black, propylene blue, Sudan III, Sudan black B, and Sudan IV.

Chemical ingredients useful as an acid generator include and are not limited to: 2-(4-methoxystyryl)-4,6-bis(trichloromethyl)-1,3,5-triazine; (4-bromophenyl)diphenylsulfonium triflate; diphenyliodonium hexafluorophosphate; and diphenyliodonium p-toluenesulfonate. It is to be understood that these are but a few acid generating chemical ingredients that can be used in conjunction with the dyes to cause the dye to be converted from a nontransparent state to a transparent state when activated.

Sudan blue is known to absorb within a wavelength range of about 500 nm to 670 nm. Triacrylsulfonium hexafluorophosphate is known to absorb within a wavelength of about 250 nm to 320 nm. Thus, within the visible wavelength, the Sudan blue dye absorbs the visible wavelength light, thereby preventing the data layer within the optical media device from being read by a light emitting and reading device, such as a laser. When, however, exposed to a source that emits radiation having a wavelength within the 250 nm to 320 nm range, the triacrylsulfonium hexafluorophosphate releases a proton that interacts with the Sudan dye and that results in shifting the absorption of the Sudan blue molecules from the visible 600 nm wavelength to the shorter wavelength that renders the data layer now readable to the light emitting and reading device. This particular process can generally be referred to as activation and photobleaching.

Generally speaking, the concentration and/or density of the dye ingredient that is present in the mask layer is such that it will not allow light emitting and reading devices conventionally used to access the data on optical media devices to successfully penetrate the masking layer and read the data from the data layer.

In the above-described example embodiment, the mask layer comprises in the range of from about 2 to 10 percent by weight of the dye material, e.g., Sudan blue, dispersed in the polymer matrix material, and in the range of from about 0.1 to 5 percent by weight acid generator ingredient, e.g., triacrylsulfonium hexafluorophosphate. The masking layer in such example embodiment can have a thickness in the range of from about 20 nm to 2 micrometers depending on the particular use embodiment.

While particular weight percentages of the ingredients, and/or thickness of the mask layer, have been disclosed, it is to be understood that the exact weight percentages of the ingredients used to form the mask layer can and will vary depending on the particular type or types of chemical ingredients or compounds used and/or the type of activator source used to achieve transparency. In the event that the activator source is a radiative element, other variables can include the wavelength of emission, the intensity of emission and/or the time of emission. Additionally, the particular thickness of the mask layer can and will vary depending on the type of chemical ingredients or compounds that are used to form the mask layer.

While particular types of dyes, chemical ingredients, and/or chemical compounds and mixtures thereof that exhibit the above-described photo bleaching process have been disclosed, it is to be understood that dyes, chemical ingredients, and/or chemical compounds other than those described above that exhibit the photo bleaching process are intended to be within the scope of this invention. For example, while a particular type of acid generator has been disclosed in an example embodiment as being activated when subjected to radiation having a wavelength in the range of from about 230 nm to 320 nm, it is to be understood that other types of acid generators having an activation wavelength outside of this range are intended to be within the scope of this invention.

Further, while the use of a particular type of activating ingredient, e.g., an acid generator, has been disclosed as being useful for converting the dye within the masking layer from an unreadable state to a readable state, it is to be understood that other types of activating ingredients can be used. Examples of such alternative activating ingredients include those that cause the desired transformation of the dye by reactive and/or other processes such as by hydroxyl generation, electron transfer, oxidation and other processes that are capable of causing the masking dye to be converted from an unreadable state to a readable state.

Further, such materials may include organic molecules dispersed or dissolved in polymers, being part of polymers, or being polymers. Still further, dyes useful for forming the mask layer of this invention may include organic and inorganic atomic and/or molecular systems.

FIG. 2. illustrates a system 22 comprising optical media device 24 of this invention as used with a concentrated light emission and reading device 26. The optical media device 24 comprises the data layer 14 and the mask layer 16 disposed thereover, wherein the mask layer is in its initial unreadable first state. The data layer 14 is shown to include a number of pits 28 and lands 30 thereon that represent the stored data information. The light emission and reading device 26 is shown to be emitting a concentrated light beam 32 onto the optical media device 24 for the purpose of reading the data contained in the data layer 14. However, the light beam 32 is unable to penetrate the mask layer when in its first state, thereby preventing the data within the data layer from being read.

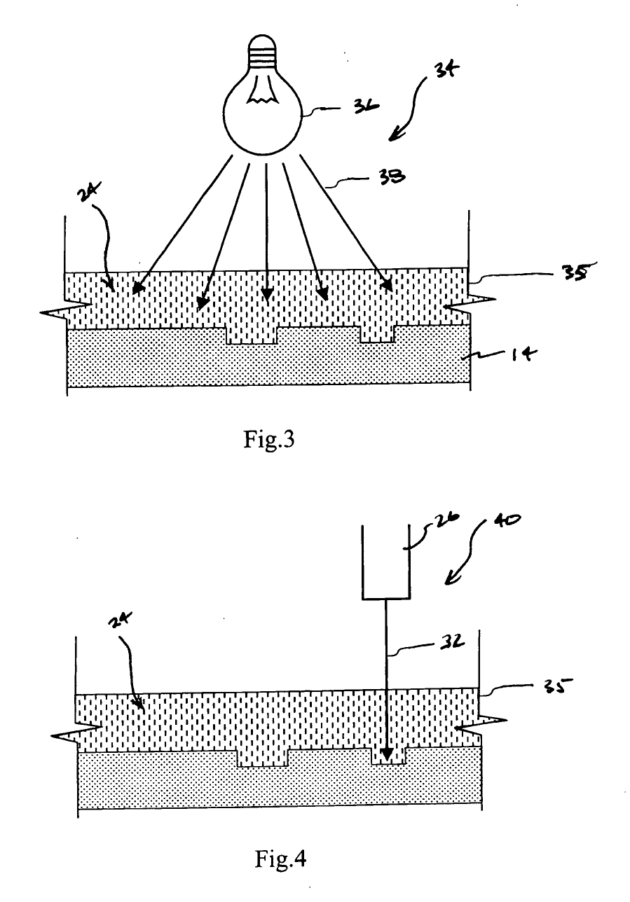

FIG. 3 illustrates a system 34 comprising the optical media device 24 of this invention as used with a concentrated light emission and reading device 26. The optical media device 24 comprises the data layer 14 and the mask layer 35 disposed thereover. As noted above in FIG. 2, the mask layer is provided in an initially unreadable first state. The system includes a light source 36 that is disposed adjacent the optical media device and over the mask layer for emitting radiation 38 within a designated wavelength to convert the mask layer from its first state to a readable second state 35.

In an example embodiment, the light source 36 is configured to emit radiation having a wavelength and/or intensity calculated to cause the chemical ingredients and/or compounds in the mask layer to undergo the changes described above to render the mask layer transparent for the purpose of making the optical media device readable by a concentrated light emission and reading device, e.g., a laser. In the specific example noted above, the light source is configured to emit radiation within the wavelength range of from about 250 nm to 320 mm.

In an example embodiment, where the optical media device is being sold from a retail establishment, it is desired that the system of FIG. 3 be carried out at the point of sale by the cashier within a short amount of time. In such example embodiment, the light source can be configured in the form of a 30 Watt source that emits ultraviolet radiation in the 250 nm to 320 nm wavelength. In such example embodiment, the process of converting the mask layer from a first to a second state can be accomplished by placing the light source a distance of approximately 5 inches from the optical media device for a period of approximately 1.2 seconds. It is, however, to be understood that the placement distance of the light source and the time to convert the mask layer can and will vary on such factors as the packaging for the optical media device, the types of materials used to form the mask layer, and the type of light source that is used.

FIG. 4 illustrates a system 40 much like that described above and illustrated in FIG. 2, except that the mask layer 35 is now in its converted second state, as rendered such by the process described above and illustrated in FIG. 3. The system 40 comprises an optical media device 24 of this invention as used with a concentrated light emission and reading device 26. The optical media device 24 comprises the data layer 14 and the mask layer 35 disposed thereover, wherein the mask layer is in its transparent second state. The light emission and reading device 26 is shown to be emitting a concentrated light beam 32 onto the optical media device 24, for the purpose of reading the data contained in the data layer 14, and because the mask layer is in its transparent second state, the light beam 32 is able to penetrate the mask layer and read the data within the data layer.

Constructed in this manner, optical media devices of this invention are initially manufactured, distributed and displayed in an initially protected or unreadable condition. Once the device has been paid for, e.g., at the point of sale, it can be converted in the manner described above to a subsequent readable condition for the purchaser's use and enjoyment. The device is constructed so that once it has been converted from an initial unreadable state to a subsequent readable state, it can be reliably read for the normal commercial life of the media.

While certain example embodiments of optical media devices of this invention have been described and illustrated here, alternative embodiments of such optical media devices are understood to be within the scope of this invention.

For example, optical media devices can be constructed according to this invention comprising only a portion of the data layer that is masked by the materials used to form the mask layer described above. In such alternative embodiment, the mask layer comprises a segment, and does not necessarily extend across the entire data layer, that masks one or more area of the data layer that is sufficient to render the optical media device unreadable or sufficiently/effectively unreadable for purpose of removing an incentive to take the device without paying for it. For example, this alternative embodiment may be desired in applications where the data on the device is protected by a form of encryption and the key is placed on a part of the media that is covered and protected by the masked section.

Further, while certain chemical dye ingredients have been described, the optical media device of this invention can be constructed having a mask layer formed from one or more different types of photo bleaching dyes of varying concentrations that are specifically tuned to withstand the varying light concentrations of light emitting and reading devices becoming available in the market, including but not limited to new technologies such as the shorter wavelength lasers used in BluRay and HD-DVD, i.e., using a blue-violet laser having a shorter wavelength of approximately 405 nm.

Still further, optical media devices of this invention may be configured having a mask layer made from dyes that respond to a specific combination of wavelengths at different intensities and for specific timeframes. For example, this may include dyes that require exposure at double the power and three times the duration of exposure to effect activation to render the optical media device readable, as such may be necessary to protect against users who have obtained the optical media illegally and are trying to activate the dye using activation equipment that was optimized for previous versions of the media.

Accordingly, is to be understood in addition to the example and alternative embodiments of the optical media devices described and illustrated herein, that other modifications and variations of the optical media devices and methods of using the same will be apparent to those skilled in the art. It is, therefore, to be understood that within the scope of the appended claims, this invention may be practiced otherwise than as specifically described.

What is claimed is:

1. An optical media device comprising:
a data layer;
a protective layer disposed over the data layer; and
a mask layer that is disposed over at least a portion of the data layer, wherein the mask layer comprises one or more chemical ingredients disposed therein, wherein in an initial first state the mask layer prevents the data layer from being read by an optical reader; and wherein in a second state the mask layer permits the data layer to be read by the optical reader.

2. The device as recited in claim 1 wherein in the first state the mask layer is optically opaque, and in the second state the mask layer is optically transparent.

3. The device as recited in claim 1 wherein mask layer is positioned on the device between the data layer and an optical reading device used to read the data.

4. The device as recited in claim 1 wherein the mask layer is interposed between the data layer and the protective layer.

5. The device as recited in claim 1 wherein the mask layer is disposed within the protective layer.

6. The device as recited in claim 1 wherein the one or more chemical ingredients are selected from chemical ingredients and chemical compounds that upon exposure to radiation having a selected wavelength change from the first to the second state.

7. The device as recited in claim 6 wherein the selected wavelength is different from that used by the optical reader used to access the data layer.

8. The device as recited in claim 7 wherein the selected wavelength is outside of the spectrum of visible light.

9. The device as recited in claim 6 wherein the optical reader is a laser and the selected wavelength is different from the laser wavelength.

10. The device as recited in claim 1 wherein the one or more chemical ingredients comprises a dye that absorbs visible or the optical reader wavelength radiation, and a further chemical ingredient that causes the dye to shift its absorption outside of the visible wavelength or the optical reader wavelength spectrum when such further chemical ingredient is exposed to an activating wavelength radiation.

11. The device as recited in claim 10 wherein the activating wavelength radiation is within the nonvisible spectrum.

12. The device as recited in claim 9 wherein the activation wavelength is within the range of from about 250 nm to 320 nm.

13. The device as recited in claim 9 wherein the activation wavelength is within the ultraviolet spectrum.

14. The device as recited in claim 9 wherein the activation wavelength is within the infrared spectrum.

15. The device as recited in claim 9 wherein the activation wavelength is in within the microwave spectrum.

16. The device as recited in claim 10 wherein the further chemical ingredient is an acid generator that produces one or more protons when exposed to the activating wavelength radiation that interact with the dye to cause the shift.

17. The device as recited in claim 10 wherein the dye is Sudan blue and the acid generating molecule is triarylsulfonium hexafluorophosphate.

18. An anti-theft optical media device comprising:
a data layer;
a protective layer disposed over the data layer;
a mask layer disposed between at least a portion of the data layer and an optical reading device that is used to read the data layer, the mask layer comprising one or more chemical ingredients that render the data layer initially unreadable by an optical reader when the mask layer is in a first state, and that renders the data layer readable by the optical reader when the mask layer is activated and converted to a second state, wherein in the first state the mask layer is optically nontransparent and in the second state the mask layer is transparent, and wherein the mask layer is activated by exposure to radiation within an activation wavelength.

19. The device as recited in claim 18 wherein the activation wavelength is outside of the visible light wavelength spectrum or the optical reader wavelength spectrum.

20. The device as recited in claim 18 wherein the chemical ingredients include one that absorbs radiation within the visible wavelength spectrum to cause the mask layer to be optically nontransparent in the first state.

21. The device as recite in claim 20 wherein the chemical ingredients include one that undergoes change when exposed to the activation wavelength to cause the mask layer to be optically transparent in the second state.

22. The device as recited in claim 20 wherein the one chemical ingredient that absorbs radiation within the visible wavelength spectrum, and the one chemical ingredient that undergoes change when exposed to the activation wavelength are different.

23. The device as recited in claim 21 wherein the one chemical ingredient that undergoes change when exposed to the activation wavelength interacts with the one chemical ingredient that absorbs radiation within the visible or optical reader wavelength spectrum to shift its absorption out of the visible or optical reader wavelength spectrum to render the mask layer optically transparent.

24. The device as recited in claim 21 wherein the one chemical ingredient that undergoes change when exposed to the activation wavelength is a photo acid generator, and the one chemical ingredient that absorbs radiation within the visible or optical reader wavelength spectrum is a bleachable dye.

25. The device as recited in claim 24 wherein the bleachable dye is Sudan blue, and the photo acid generator is triarylsulfonium hexafluorophosphate.

26. A method for making an optical media device having an anti-theft feature, the optical media device comprising a data layer and a protective layer disposed over the data layer, the method comprising the step of placing a mask layer over at least a portion of the data layer, the mask layer being positioned on the optical media device between the data layer and an optical reading device used to read the data layer, the mask layer being formed from a material that is optically nontransparent to the optical reading device when it is in a first state to render the optical media device unreadable, the material further being convertible to an optically transparent second state to render the optical media device readable.

27. The method as recited in claim 26 further comprising the step of exposing the optical media device to radiation at an activation wavelength to convert the mask layer to the second state.

28. The method as recited in claim 27 wherein the activation wavelength is within the nonvisible light spectrum.

29. The method as recited in claim 27 wherein the material comprise a first ingredient that absorbs radiation within the visible light or optical reader wavelength spectrum, and a second ingredient that causes the first ingredient to shift its light absorption wavelength when the second ingredient is exposed to the activation wavelength.

30. The method as recited in claim 29 wherein the first ingredient absorbs radiation at the optical reader wavelength, and wherein the optical reader wavelength is outside of the region within the visible light spectrum.

31. The method as recited in claim 27 wherein the activation wavelength is outside of spectrum of visible light or the spectrum of light used by the optical reader.

32. The method as recited in claim 29 wherein the second ingredient is a proton generator, and wherein after the step of exposing, the second ingredient generates protons that interact with the first ingredient to shift its absorption outside of the visible light or optical reader wavelength spectrum.
